(19) United States
(12) Patent Application Publication
(10) Pub. No.: US 2012/0234982 A1
(43) Pub. Date: Sep. 20, 2012

(54) Retractable Plane Structure, and Satellite Comprising Such a Structure

(75) Inventor: Rodolphe KRAWCZYK, Villeneuve-Loubet (FR)

(73) Assignee: THALES, Neuilly-sur-Seine (FR)

(21) Appl. No.: 13/419,302

(22) Filed: Mar. 13, 2012

(30) Foreign Application Priority Data
Mar. 17, 2011 (FR) 11 00808

(51) Int. Cl. B64G 1/22; E04H 12/18

(52) U.S. Cl. 244/172.6; 52/645

(57) ABSTRACT

A retractable plane structure includes an unfoldable membrane linked to N main assemblies of n main rods connected end-to-end by n−1 articulations respectively equipped with a deployment means, and further includes at least one intermediate assembly of n intermediate rods, less bulky than said main rods, connected end-to-end by n−1 articulations.

### CROSS-REFERENCE TO RELATED APPLICATION

This application claims priority to foreign French patent application No. FR 1100808, filed on Mar. 17, 2011, the disclosure of which is incorporated by reference in its entirety.

### FIELD OF THE INVENTION

The present invention relates to a retractable plane structure, and satellite comprising such a structure.

### BACKGROUND

The deployment of large plane structures, notably in space, such as solar sails or large sun shields, is becoming more and more widespread.

Deploying a plane structure with large dimensions in space is extremely demanding and involves constraints on launch, since a spacecraft launch leads to conditions of compactness at the launch that are all the more drastic the larger the surface of its membrane once deployed.

The invention is particularly relevant for space applications. The reason for this is that, when it has a retracted or folded up configuration, its reduced volume is particularly adapted to the constraints of compactness imposed during the launch. On the contrary, its active or deployed configuration allows it to be operational when the satellite is operational in space.

In the field of space applications, retractable structures of the sun shield type are known, equipped with assemblies of rods connected end-to-end by articulations.

Such structures are not adapted to a membrane with a large size for a number of rods equal to at least two, because a minimum tension is required for these membranes: in order to avoid any risk of tearing during the deployment of the satellite, the membrane elements must exhibit slack, i.e. their surface area under tension must be greater than their deployed surface area, but this slack must be recovered, at least in part for solar sail and especially sun shield applications.

### SUMMARY OF THE INVENTION

One aim of the invention is to provide a retractable plane structure with a limited risk of tearing the membrane when the satellite is deployed.

According to one aspect of the invention, a retractable plane structure is provided, comprising an unfoldable membrane linked to N main assemblies of n main rods connected end-to-end by n−1 articulations respectively equipped with a deployment means, and at least one intermediate assembly of n intermediate rods, less bulky than said main rods, connected end-to-end by n−1 articulations.

Such a structure limits the risks of tearing the membrane during its deployment, while at the same time ensuring a sufficient tension of the membrane elements when the deployment has finished.

In one embodiment, said intermediate rods are lighter than said main rods.

The intermediate rods are very simple to implement owing to their lightness.

According to one embodiment, said articulations connecting said intermediate rods of an intermediate assembly are respectively equipped with a deployment means.

Thus, these intermediate rods can also assist in the deployment of the main rods in the case where a stiff point is encountered during the deployment of some of the main articulations.

In one embodiment, at least a part of said deployment means are passive, for example comprising a compression spring or a Carpentier joint.

The use of passive deployment means is financially more advantageous and technically simpler than that of active means of the electric motor type, and is sufficient in that this type of deployment is most often one shot and not followed by a retraction, the applications targeted for this type of deployable structure only requiring a structure to be deployed once and for all.

As a variant, or in combination, at least a part of said deployment means comprises an actuator, or, in other words, a controlled device that converts the energy supplied to it into work useful for the execution of tasks in an automated system, in this case a deployment of the two rods connected by the articulation equipped with an actuator.

For example, N can be greater than or equal to 3.

According to another aspect of the invention, a satellite is provided comprising a structure such as previously described, mounted in a fixed manner onto a support element of said satellite, as a base for at least a part of said assemblies of rods, by means of articulations equipped with deployment means such as compression springs or Carpentier joints.

Such a satellite can thus be fitted with a retractable plane structure, with a large surface area when deployed, substantially limiting the risks of tearing the membrane when it is deployed, and allowing a compactness compatible with the current launchers.

In one embodiment, an assembly of rods of said structure, when the latter is folded up or retracted, is substantially perpendicular to the surface of said support element.

Thus, the compactness is optimized for a launch.

### BRIEF DESCRIPTION OF THE DRAWINGS

The invention will be better understood upon studying a few embodiments described by way of non-limiting examples and illustrated by the appended drawings in which:

FIG. 1 illustrates schematically one example of a retractable plane structure according to one aspect of the invention; and

FIGS. 2a, 2b, 2c and 2d, illustrate schematically, in a cross-sectional view, the deployment of a retractable plane structure according to FIG. 1, belonging to a satellite.

### DETAILED DESCRIPTION

In all the figures, the elements having the same references are similar.

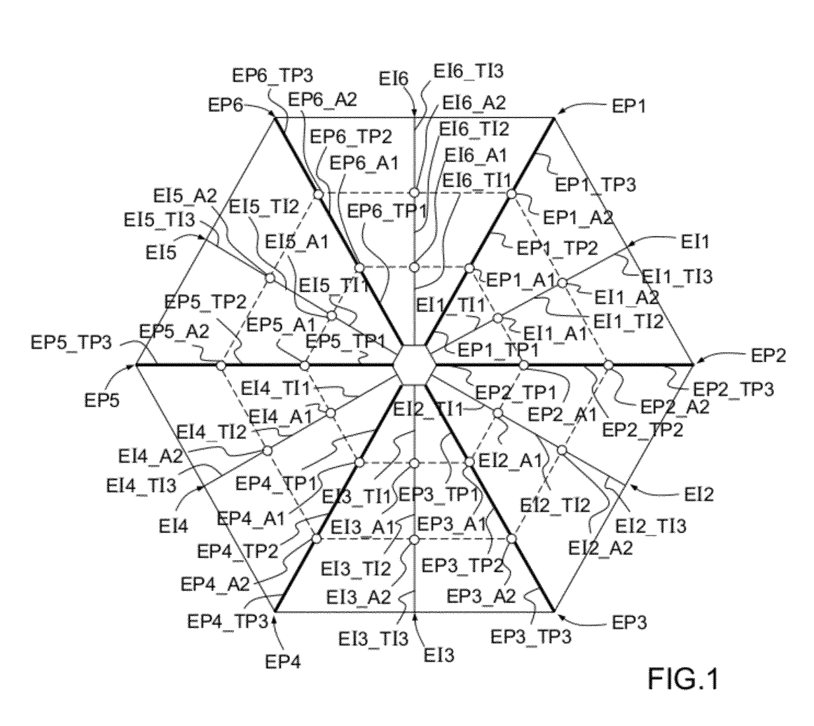

FIG. 1 shows schematically one example of a retractable plane structure SPE comprising an unfoldable membrane MD, for example made of mylar, of kapton, or of woven carbon fiber, linked to N main assemblies EP1, EP2, . . . , EPK, . . . , EPN of n main rods EPK_TP1, EPK_TP2, . . . , EPK_TPn connected end-to-end by n−1 articulations EPK_A1, EPK_A2, . . . , EPK An−1 respectively equipped with a deployment element. The retractable plane structure SPE also comprises at least one intermediate assembly EI1, EI2, . . . , EIK, . . . , EIN of n intermediate rods EIK_TI1, EIK_TI2, . . . , EIK_TIn, less bulky than the main rods, connected end-to-end by n−1 articulations EIK_A1, EIK_A2, . . . , EIK_An−1.

In the example in FIG. 1, the number N of main assemblies EPK is taken equal to 6 (EP1, EP2, EP3, EP4, EP5, and EP6), the number of intermediate assemblies EIK is taken equal to 6 (EI1, EI2, EI3, EI4, EI5, and EI6), and the number n of rods per main assembly EPK and intermediate assembly EIK is taken equal to 3.

The intermediate rods EIK_TI1, EIK_TI2, . . . , EIK_TIn are lighter than the main rods EK_TP1, EK_TP2, . . . , EK_TPn. Thus, with no risk of tearing the unfoldable membrane MD, and with reduced mass and cost, a sufficient tension is applied to MD.

In this case, the articulations EIK_A1, EIK_A2, . . . , EIK_An−1 connecting the intermediate rods EIK_TI1, EIK_TI2, . . . , EIK_TIn of an intermediate assembly EI1, EI2, . . . , EIK, . . . , EIN are respectively equipped with a deployment element.

At least a part of the deployment means may be passive, for example comprising compression springs or Carpentier joints. The use of passive elements does not require a force supplied by an external element to cause the deployment of the rods that they connect. The means for adjustment of the movement are of the conventional type already used on solar generators (centrifugal regulator, potentially motor-brake for one assembly of rods, or even for the assembly of all the rods) and are not considered in the present patent application. If one or more retractions were considered necessary, the compression springs or Carpentier joints should then be replaced by electric motors.

As a variant, or in combination, at least a part of the deployment elements can comprise an actuator. Such an embodiment is not illustrated in the figures.

For large structures, N can be greater than or equal to 3.

This type of structure is perfectly adapted to being mounted in a fixed manner onto a support element SUP of said satellite, as a base for at least a part of the assemblies EPK, EIK of rods, by means of articulations EPK_A0, EIK_A0 equipped with deployment means, on a support element SUP of the satellite.

When the structure SPE of the satellite is retracted, during a launch, one assembly E1, E2, . . . , EK, . . . , EN, EI1, EI2, . . . , EIK, . . . , or EIN of rods of the structure SPE is substantially perpendicular to the surface of the support element SUP.

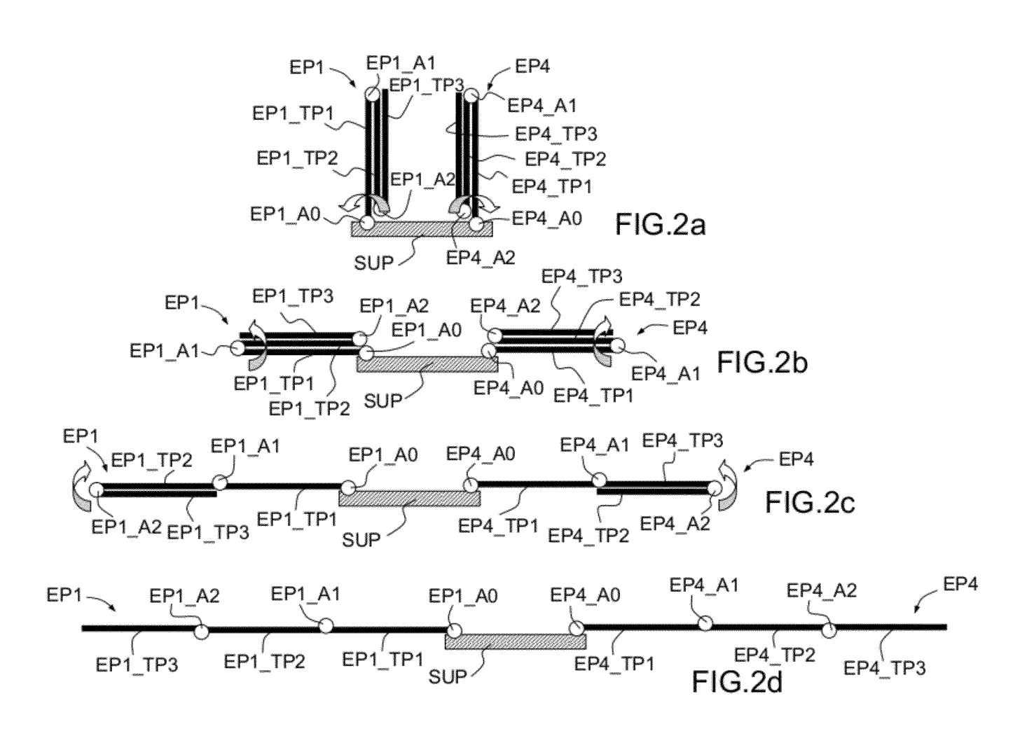

In FIGS. 2a, 2b, 2c and 2d, a cross-sectional schematic view is shown of the deployment of a retractable plane structure SPE mounted onto the surface of a support element SUP of a satellite. In the example described, this is a structure SPE according to FIG. 1 (N=6 and n=3).

Initially, during the launch, the retractable plane structure SPE is folded up. In FIG. 2a, for example, two diametrically opposing main assemblies EP1 and EP4 are shown in cross section.

Each of these main assemblies comprises its three main rods EPK_TP1, EPK_TP2, and EPK_TP3 folded up in accordion fashion, by means of their articulations EPK_A1 and EPK_A2, and which are mounted in a rotatable manner onto the support SUP by means of their articulation EPK_A0.

Once in orbit, the deployment of the plane structure is carried out, as illustrated in FIGS. 2a, 2b, 2c and 2d. First of all, the assemblies folded up in accordion fashion open up by performing a rotation substantially by 90° about their articulation fixed to the support SUP, in such a manner as to deploy a first annular section of the unfoldable membrane MD. The structure SPE is then configured, as seen in cross section, according to the state in FIG. 2b.

Subsequently, a rotation of 180° is performed by the second and third rods EPK_TP2 and EPK_TP3 of the assemblies EPK, toward the outside, about their articulation EPK_A1, in such a manner as to deploy a second annular section of the unfoldable membrane MD. The structure SPE is then configured, as seen in cross section, according to the state in FIG. 2c.

Finally, a rotation of 180° is performed by the third rods EPK_TP3 of the assemblies EPK, toward the outside, about their articulation EPK_A2, in such a manner as to deploy a third annular section of the unfoldable membrane MD. The structure SPE is then, as seen in cross section, according to the state in FIG. 2d, completely deployed.

It goes without saying that, during this deployment, the intermediate assemblies are deployed in a similar fashion. The assemblies of rods are not necessarily all linked, as a base, to the support SUP, and all of them do not necessarily comprise an articulation mounted in a rotatable manner onto the support SUP.

All the articulations can be deployed by passive deployment means such as compression springs or Carpentier joints and/or active deployment means such as actuators.

1. A retractable plane structure, comprising:
an unfoldable membrane linked to N main assemblies of n main rods connected end-to-end by n−1 articulations respectively equipped with a deployment means, and
at least one intermediate assembly of n intermediate rods, less bulky than said main rods, connected end-to-end by n−1 articulations.

2. The retractable plane structure as claimed in claim 1, in which said intermediate rods are lighter than said main rods.

3. The retractable plane structure as claimed in claim 1, in which said articulations connecting said intermediate rods of said intermediate assembly are respectively equipped with a deployment means.

4. The retractable plane structure as claimed in claim 1, in which at least a part of said deployment means are passive.

5. The retractable plane structure as claimed in claim 4, in which a passive deployment means comprises a compression spring or a Carpentier joint.

6. The retractable plane structure as claimed in claim 1, in which at least a part of said deployment means comprises an actuator.

7. The retractable plane structure as claimed in claim 1, in which N is greater than or equal to 3.

8. A satellite comprising a retractable plane structure as claimed in claim 1, mounted in a fixed manner onto a support element of said satellite, as a base for at least a part of said assemblies of rods, by means of articulations equipped with deployment means.

9. The satellite as claimed in claim 8, in which an assembly (E1, E2, . . . , EK, . . . , EN, EI1, EI2, . . . , EIK, . . . , EIN) of rods of said structure, when the latter is folded up, is substantially perpendicular to the surface of said support element.
